(19) United States
(12) Patent Application Publication
(10) Pub. No.: US 2024/0122098 A1
(43) Pub. Date: Apr. 18, 2024

(54) PUSH ROD MECHANISM AND LAWNMOWER HAVING THE SAME

(71) Applicant: JIANGSU DONGCHENG TOOLS TECHNOLOGY CO., LTD., Nantong (CN)

(72) Inventor: Weiping HOU, Nantong (CN)

(21) Appl. No.: 18/398,246

(22) Filed: Dec. 28, 2023

Related U.S. Application Data
(63) Continuation of application No. PCT/CN2022/114158, filed on Aug. 23, 2022.

(30) Foreign Application Priority Data
Aug. 24, 2021 (CN) 202110976600.1

(51) Int. Cl. A01D 34/00; A01D 75/18

(52) U.S. Cl. CPC A01D 34/001; A01D 75/18; A01D 2101/00

(57) ABSTRACT

A push rod mechanism includes a lower push rod and an upper push rod relatively stretchable and retractable, and a telescopic control assembly. The lower push rod is provided with a through hole passing through a side wall. The telescopic control assembly includes a limiting member. The limiting member abuts against a side wall of the upper push rod and has a position-limiting state for limiting movement of the upper push rod relative to the lower push rod. The telescopic control assembly includes an operating member capable of pressing against the limiting member, and an operating member for controlling the movement of the operating member. The operating member defines a first position and a second position. In the first position, the operating member keeps the limiting member in the limiting state. In the second position, the operating member allows the limiting member to be released from the position-limiting state.

### CROSS REFERENCE TO RELATED APPLICATIONS

The present application is a continuation of International Patent Application No. PCT/CN2022/114158, filed Aug. 23, 2022, which claims the priority to Chinese Patent Application No. 202110976600.1, filed Aug. 24, 2021, both of which are herein incorporated by reference in their entireties.

### TECHNICAL FIELD

The present disclosure relates to a push rod mechanism and a lawnmower having the push rod mechanism.

### BACKGROUND

A lawnmower is provided with an operating rod for pushing. The operating rod usually includes a lower push rod connected to two sides of a housing of the lawnmower and an upper push rod connected to the lower push rod. The lower push rod is equipped with a grip part for pushing during operation of the lawnmower.

When the lawnmower is in operation, the operating rod extends a certain length towards a rear of the lawnmower for an operator to work within a safe distance of a certain length away from a cutting tool. When the lawnmower is not in operation, it needs to be kept in place and stored. People have designed the operating rod to be foldable or telescopic for storage purposes, and in order to meet safety requirements, a safety switch mechanism has been added during folding or telescopic process to reduce the possibility of accidents. However, existing technical solutions are either too complex in structure, or have low reliabilities and potential safety hazards.

In view of this, it is indeed necessary to provide an improved push rod mechanism to overcome the shortcomings in the related art.

### SUMMARY OF THE DISCLOSURE

A technical solution provided by the present disclosure is a push rod mechanism. The push rod mechanism includes a lower push rod and an upper push rod relatively telescopic to each other; and a telescopic control assembly sleeved at a joint position between the lower push rod and the upper push rod. The lower push rod defines a through hole passing through a side wall of the lower push rod. The telescopic control assembly includes a limiting member at least partially accommodated in the through hole. The limiting member abuts against the side wall of the upper push rod and has a position-limiting state that restricts stretch and telescopic of the upper push rod relative to the lower push rod. The telescopic control assembly includes an operating member capable of pressing against the limiting member, and an operating handle for controlling movement of the operating member. The operating handle defines a first position and a second position and is able to move between the first position and the second position. When the operating handle is in the first position, the operating member presses against the limiting member to keep the limiting member in a limited state. When the operating handle is in the second position, the operating member gives way to the limiting member to allow the limiting member to exit the position-limiting state.

Another technical solution provided by the present disclosure is a lawnmower. The lawnmower includes a housing, a grass collection bag located behind the housing, and a push rod mechanism located on two sides of the housing. The push rod mechanism is the push rod mechanism described above, and the push rod mechanism is located above the grass collection bag.

### BRIEF DESCRIPTION OF THE DRAWINGS

The following is a further detailed explanation of specific embodiments of the present disclosure in conjunction with the accompanying drawings.

FIG. 1 is a structural schematic view of an overall structure of a lawnmower according to an embodiment of the present disclosure.

FIG. 2 is a structural schematic view of a push rod mechanism of the lawnmower shown in FIG. 1.

FIG. 3 is an enlarged schematic view of a partial structure of the push rod mechanism shown in FIG. 2.

FIG. 4 is an enlarged schematic view of the partial structure shown in FIG. 3 in another state.

FIG. 5 is a schematic view of a partial structure of the push rod mechanism shown in FIG. 1.

FIG. 6 is an enlarged schematic view of a telescopic control assembly of the push rod mechanism shown in FIG. 5.

FIG. 7 is an enlarged schematic view of the telescopic control assembly shown in FIG. 6 in another state.

### DETAILED DESCRIPTION

Terms used in the present disclosure are for the purpose of describing particular embodiments only, and are not intended to limit the present disclosure. For example, terms indicating orientation or positional relationship such as “up”, “down”, “front”, and “back” described below are only based on the orientation or positional relationship shown in the drawings, and are only for the convenience of describing the present disclosure and simplifying the description, rather than indicating or implying that the device/element referred to must have a specific orientation or be constructed and operated in a specific orientation, and therefore are not able to be construed as limiting the present disclosure.

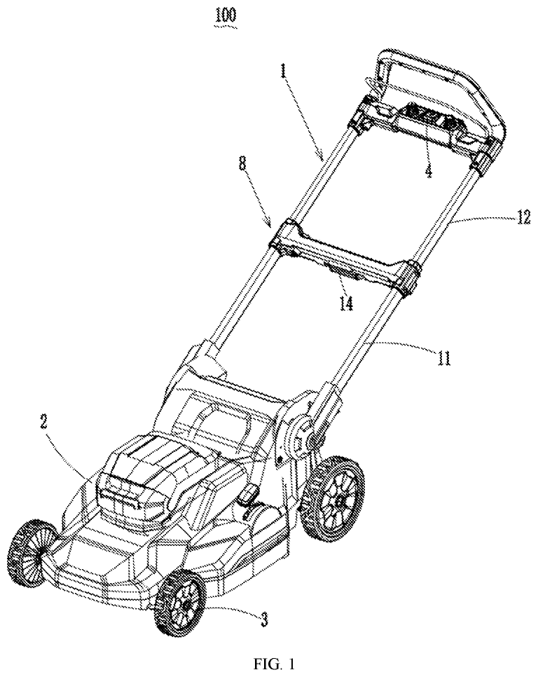

As shown in FIG. 1, a lawnmower 100 is provided in some embodiments of the present disclosure. The lawnmower 100 includes a housing 2. A motor and a transmission mechanism driven by the motor are arranged inside the housing 2. A blade driven by the transmission mechanism to rotate is arranged at a lower part of the housing 2, and a grass collection bag is arranged at a rear part of the housing 2. In an embodiment, the lawnmower 100 is a DC (direct current) electric lawnmower, and the lawnmower 100 is also provided with a battery compartment for receiving a battery pack. When the lawnmower 100 starts, the battery pack supplies power to the motor, and the motor outputs kinetic energy to the blade through the transmission mechanism, thereby realizing trimming of the lawn. Trimmed grass debris enters the collection bag through an air duct inside the housing 2. In addition, the housing 2 of the lawnmower 100 is supported by four walking rollers 3. A push rod mechanism 1 is provided at a rear part of the lawnmower 100. A start switch 4 is provided on the push rod mechanism 1. The walking roller 3 may be electrically connected to the start switch 4. In other words, after the lawnmower 100 starts, the walking roller 3 may roll as required until it reaches an area where grass trimming is needed. After grass trimming is finished, the lawnmower 100 may continue to roll to another area where grass trimming is needed.

In the embodiment, the lawnmower 100 also includes the push rod mechanism 1, and the push rod mechanism 1 is arranged on two sides of the housing 2 and is located above the grass collection bag. The push rod mechanism 1 may be retracted and folded for storage when not in use, thereby saving storage space. In order to prevent a user from accidentally starting the lawnmower 100 when the push rod retracts or folds and thus causing safety accidents, the push rod mechanism 1 is provided with a safety switch 5. In other words, when the push rod mechanism 1 is in a folded and retracted state, the lawnmower 100 is not able to walk or perform cutting operations. The push rod mechanism 1 and the safety switch 5 are described in detail below.

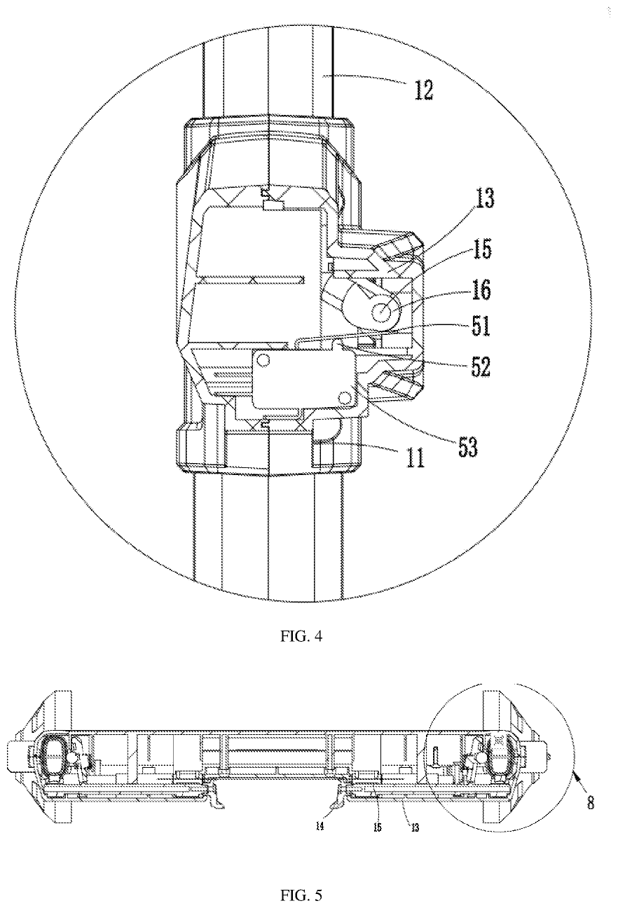

As shown in FIG. 1, FIG. 4, and FIG. 5, the push rod mechanism 1 includes a lower push rod 11, an upper push rod 12, and a telescopic control assembly 8 sleeved at a connection position between the lower push rod 11 and the upper push rod 12. The lower push rod 11 and the upper push rod 12 are relatively telescopic. The lower push rod 11 is provided with a through hole passing through a side wall of the lower push rod 11. The telescopic control assembly 8 includes a limiting member at least partially accommodated in the through hole. The limiting member abuts against a side wall of the upper push rod 12, and has a position-limiting state that restricts the upper push rod 12 to stretch or retract relative to the lower push rod 11. The telescopic control assembly 8 also includes an operating member capable of pressing against the limiting member, and an operating handle 14 for controlling a movement of the operating member. The operating handle 14 defines a first position and a second position, and moves between the first position and the second position. When the operating handle 14 is in the first position, the operating member presses against the limiting member to keep the limiting member in a position-limiting state. When the operating handle 14 is in the second position, the operating member gives way to the limiting member to allow the limiting member to exit the position-limiting state.

Due to restriction of the operating member on the limiting member, the limiting member may exit the position-limiting state only when the operating member moves to the second position, thereby allowing the upper push rod 12 to stretch or retract relative to the lower push rod 11. During the operation of the lawnmower 100 (i.e., when the operating handle 14 is in the first position), a telescopic operation between the upper push rod 12 and the lower push rod 11 is prohibited, such that operation safety of the lawnmower 100 is improved. The push rod mechanism 1 has a simple structure, is easy to be manufactured and assembled, and has high stability.

The limiting member and the operating handle 14 of the push rod mechanism 1 have a mutually limiting effect. Only when the upper push rod 12 is stretched from the lower push rod 11 to a suitable working position, and the limiting member enters a position between the upper push rod 12 and the lower push rod 11 and remains in the position-limiting state, the operating handle 14 may be fixed in the first position (i.e., locked state), thereby allowing the lawnmower 100 to start. On the other hand, the limiting member may only exit the position-limiting state only when the operating member is moved to the second position (i.e., unlocked state), allowing the upper push rod 12 to stretch or retract relative to the lower push rod 11. The telescopic control assembly 8 arranged in this way has a simple and clever structure, which may effectively reduce the possibility of misoperation of the lawnmower 100 and safety accidents as a result.

In the embodiment, the operating handle 14 rotates around a pivot shaft 15 between the first position and the second position. The operating handle 14 is connected to the pivot shaft 15 in a transmission way, and the operating member is connected to the pivot shaft 15. The operating handle 14 is connected to the pivot shaft 15 in the transmission way through a non-circular contact surface, such as cooperation between a hexagonal surface and an inner hexagonal surface. Those skilled in the art may think of many alternative ways, which will not be exemplified here. In summary, the operating handle 14 drives the pivot shaft 15 to rotate through a rotating operation, such that the operating member rotates accordingly. Therefore, when the operating handle 14 rotates between the first position and the second position, the operating member also rotates between a position of pressing against or giving way to the limiting member.

In other embodiments, the manner in which the operating handle 14 drives the operating member to move may also be linear reciprocating motion, vertical conversion motion or other motion modes, which will not be repeated here.

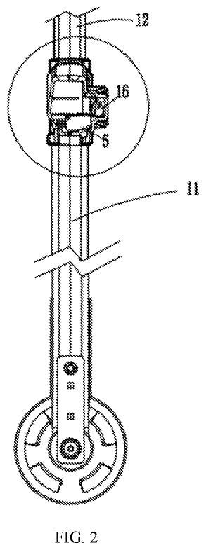

As shown in FIG. 1-FIG. 3, the push rod mechanism 1 includes a start switch 4 and a safety switch 5 connected to the start switch 4. The safety switch 5 is arranged in the telescopic control assembly 8. When the operating handle 14 is in the second position, the safety switch 5 is triggered, and the start switch 4 is restricted to start. When the operating handle 14 is in the first position, the safety switch 5 is not triggered, and the start switch 4 is allowed to start. The safety switch 5 is linked with the operating handle 14. In other words, the safety switch 5 is related to the telescopic state of the upper push rod 12. When the upper push rod 12 is in a retracted state or allowed to retract, the safety switch 5 is triggered to remind the user that mowing operation could not be performed at this time.

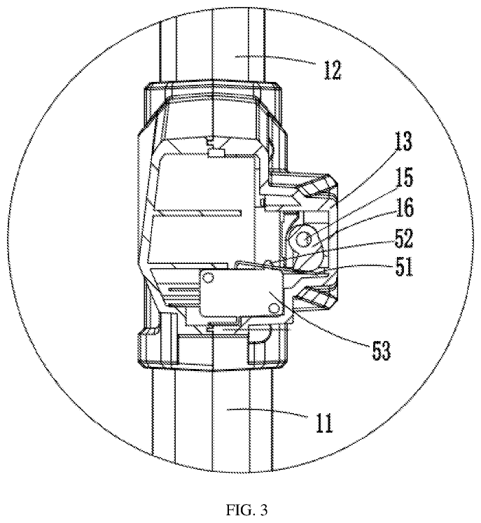

As shown in FIG. 3 and FIG. 4, the safety switch 5 has a switch shell 53, a button 52 protruded from the switch shell 53 and an activation rod 51 connected to one side of the button 52. The telescopic control assembly 8 includes a cam 16 protruded radially from the pivot shaft 15. A radius of rotation of the cam 16 changes uniformly along a circumference of the pivot shaft 15. Rotation of the operating handle 14 drives the cam 16 to rotate. When the operating handle 14 rotates to the first position (as shown in FIG. 3), a portion with maximum rotation radius of the cam 16 presses the activation rod 51 to trigger the button 52, thus activating the safety switch 5. When the operating handle 14 is turned to the second position (as shown in FIG. 4), a portion with minimum rotation radius of the cam 16 contacts the activation rod 51 and fails to trigger the button 52. The operating handle 14 cooperates with the cam 16 which triggers the safety switch 5, allowing the operating handle 14 to trigger the safety switch 5 with just one turn of the operating handle 14 while changing position. It simply and directly turns off the start switch without requiring response time and is able to timely implement safety protection for users.

Both the upper push rod 12 and the lower push rod 11 are hollow tubular members, which may be round tubes or flat tubes. The upper push rod 12 and the lower push rod 11 shown in the embodiment are both flat tubes. The push rod mechanism 1 in the embodiment includes two lower push rods 11, which are respectively pivotally arranged on two sides of the housing 2. Correspondingly, there are also two upper push rods 12, and two ends of the telescopic control assembly 8 are respectively sleeved on junction positions of the lower push rods 11 and the upper push rods 12.

Two sets of telescopic control assemblies are provided in the embodiment, that is, a first limiting member and a first operating member cooperating with the first limiting member, and a second limiting member and a second operating member cooperating with the second limiting member. In the embodiment, the first operating member and second operating member are in cooperation with the operating handle 14. In other words, when the operating handle 14 rotates, the first operating member and the second operating member are controlled to simultaneously press against the first limiting member and the second limiting member respectively, or to simultaneously give way to the first limiting member and second limiting member respectively. Simultaneous application of the two sets of telescopic control assemblies facilitates to strengthen the stability of the position-limiting state and provides double guarantees for telescopic control. As shown in FIG. 5-FIG. 7, both sets of telescopic control assemblies are included and will be described one by one below.

As shown in FIG. 5-FIG. 7, the through hole includes a positioning hole 111 running through a tube wall of the lower push rod 11, and the upper push rod 12 is provided with a limiting hole 121 that penetrates a tube wall and coincides with the positioning hole 111. The limiting member includes a first limiting member. The first limiting member has a tendency to maintain entry into the limiting hole 121 to limit stretch and retraction of the upper push rod 12. When the first limiting member enters the limiting hole 121 coincident with the positioning hole 111, a relative position of the upper push rod 12 and the lower pushing rod 11 is locked by the first limiting member, then it is difficult for the upper push rod 12 and the lower pushing rod 11 to move relative to each other.

In the embodiment, the telescopic control assembly 8 includes a shell 13 for accommodating the first limiting member and the operating member. The first limiting member includes a limiting plate 17 pivotally arranged on the shell 13 and a limiting ball 18 connected to the limiting plate 17. The limiting ball 18 is at least partially accommodated in the positioning hole 111, and a diameter of the limiting ball 17 is equivalent to a size of the positioning hole 111. In the embodiment, both the positioning hole 111 and the limiting hole 121 are round holes, and the limiting ball 18 is a steel ball with high strength and wear resistance. In other embodiments, the limiting ball 18 may also be made of other metal or plastic materials.

In the embodiment, the limiting plate 17 is provided with a receiving groove for accommodating the limiting ball 18, or providing a receiving space for the limiting ball 18. The limiting plate 17 is pivotally connected to the shell 13, such that the limiting ball 18 may enter or exit the positioning hole 111 along with the limiting plate 17.

The telescopic control assembly 8 also includes an elastic member 81 disposed between the limiting plate 17 and the shell 13. The limiting plate 17 has a movement tendency to push the limiting ball 18 into the limiting hole 121 under elastic force of the elastic member 81. The limiting plate 17 is elastically supported and has a movement tendency towards the limiting hole 121. In this way, when the upper push rod 12 is stretched or retracted in place relative to the lower pushing rod 11, the limiting plate 17, driven by the elastic force, drives the limiting ball 18 through the positioning hole 111 and the limiting hole 121 to enter the tube wall of the upper pushing rod 12. In this case, the operating handle 14 may only be moved from the second position to the first position, and the lawnmower 100 may only be started when the operating handle 14 is moved to the first position. In the first position, due to the pressing of the operating member, the limiting ball 18 is not able to withdraw from the limit hole 121, such that telescopic operation of the upper push rod 12 relative to the lower push rod 11 is limited. In the second position, the operating member gives way to the limiting plate 17, and the limiting ball 18 may be pushed out of the positioning hole 111 through the tube wall of the upper push rod 12 to cross a surface of the limiting ball 18 for telescopic operation.

The arrangement of the elastic member 81 allows the limiting plate 17 to move towards the positioning hole 111, such that the limiting ball 18 is kept in the positioning hole 111 and the limiting hole 121. In the embodiment, the elastic member 81 is a spring, and the spring is stretched in a natural state. The compressed spring allows the limiting plate 17 to have a tendency to approach the positioning hole 111. In other embodiments, the elastic member 81 may also be a torsion spring, and two leading ends of the torsion spring respectively press against one end of the shell 13 and one end of the limiting plate 17, such that the limiting plate 17 keeps a tendency to approach the positioning hole 111 in a natural state.

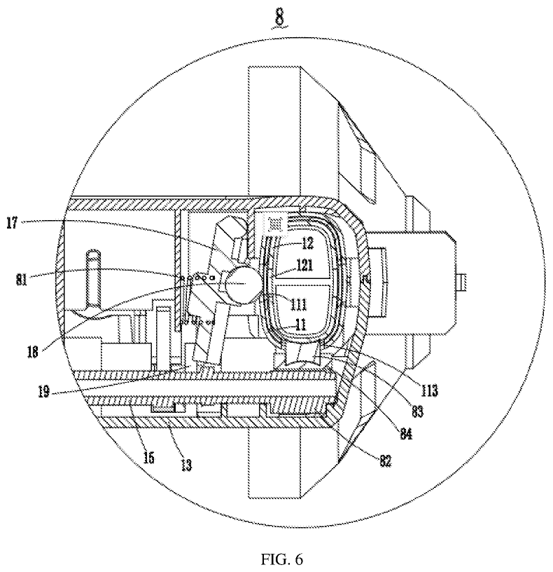

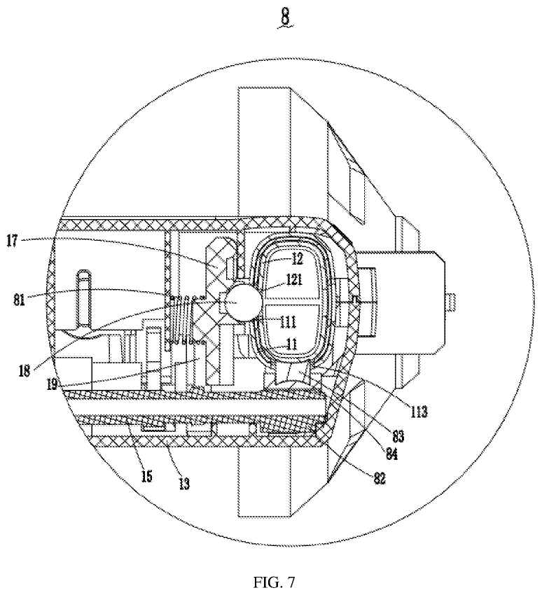

As illustrated in FIG. 6 and FIG. 7, the operating member includes a first operating member, and the first operating member is a stopping member 19 disposed at the pivot shaft 15. The stopping member 19 and limiting plate 17 are arranged adjacent to each other in an axial direction along the pivot shaft 15. When the operating handle 14 is in the first position (as shown in FIG. 7), the stopping member 19 overlaps at least partly with limiting plate 17 along a circumference of the pivot shaft 15. When the operating handle 14 is in the second position (as shown in FIG. 6), the stopping member 19 is staggered with the limiting plate 17 along the circumference of the pivot shaft 15. In other words, the stopping member 19 is located at one side of the limiting plate 17 away from the positioning hole 111 along the axial direction. In the first position, the stopping member 19 presses against the limiting plate 17, preventing the limiting plate 17 along with the limiting ball 18 from exiting the positioning hole 111, such that the upper push rod 12 is not able to stretch or retract relative to the lower push rod 11 in this case. In the second position, the stopping member 19 is rotated by a certain angle from a position that partially coincides with the limiting plate 17 to give way to the limiting plate 17, giving the limiting plate 17 a space for pivotable movement, thus allowing the limiting ball 18 to withdraw from the positioning hole 111, such that the relative telescopic movement of the upper push rod 12 and the lower push rod 11 is realized.

When the operating handle 14 is rotated, the first operating member (i.e., the stopping member 19) is driven to rotate to arrive at one position of pressing against the first limiting member (i.e., the limiting plate 17 with the limiting ball 18) and another position of giving way to the first limiting member, such that the telescopic operation of the upper push rod 12 relative to the lower push rod 11 is restricted or unrestricted.

As shown in FIG. 5-FIG. 7, the telescopic control assembly 8 further includes a second limiting member and a second operating member cooperating with each other. The through hole of the lower push rod 11 also includes a strip hole 113 defined on one side facing the pivot shaft 15. The second limiting member is a flexible member 83 accommodated in the strip hole 113. The flexible member 83 penetrates through the strip hole 113 of the lower push rod 11 and presses against one side wall of the upper push rod 12. The flexible member 83 enters a position between the upper push rod 12 and the lower push rod 11 through the strip hole 113 to limit the relative telescopic operation of the upper push rod 12 and the lower push rod 11.

When the second limiting member is the flexible member 83, the second operating member cooperating with it is a second cam 82 arranged around the pivot shaft 15. The second cam 82 is in alignment with the flexible member 83 along the axial direction of the pivot shaft 15. The second cam 82 has a short diameter and a long diameter around an outer circumference of the pivot shaft 15. When the operating handle 14 is in the first position (as shown in FIG. 7), a part of the second cam 82 with the long diameter presses against the flexible member 83. When the operating handle 14 is in the second position (as shown in FIG. 6), a part of the second cam 82 with the short diameter is facing the flexible member 83. The second cam 82 rotates along with the operating handle 14. When the operating handle 14 is in the first position and the second position respectively, the second cam 82 respectively presses against or gives way for the flexible member 83, such that the flexible member 83 changes between a position-holding state and a position-exiting state, thereby restricting or unrestricting the telescopic operation of the upper push rod 12 relative to the lower push rod 11.

When the upper push rod 12 and the lower push rod 11 are stretched-retracted in place, the operating handle 14 may be moved to and fixed in the first position. In this way, the second cam 82 moving with the operating handle 14 rotates to a position where a part of the second cam 82 with the long diameter presses against an outer wall of the upper push rod 12 through the flexible member 83, thereby preventing the telescopic movement of the upper push rod 12 relative to the lower push rod 11. When the upper push rod 12 needs to be retracted, the operating handle 14 is rotated to move to the second position. The second cam 82 rotates along with the operating handle 14 to a position where a part of the second cam 82 with the short diameter faces the flexible member 83. At this time, a length of a protrusion of the second cam 82 is not deep enough to touch the upper push rod 12, thus not capable of limiting the upper push rod 12, and the upper push rod 12 may be stretched and retracted relative to the lower push rod 11.

The telescopic control assembly 8 further includes a receiving part 84 located between the flexible member 83 and the second cam 82. The receiving part 84 is configured to receiving and supporting the flexible member 83.

As shown in FIG. 5-FIG. 7 in conjunction with FIG. 3 and FIG. 4, the cam 16, the stopping member 19 and the second cam 82 are all arranged at the pivot shaft 15 and are driven synchronously with the operating handle 14. When the upper push rod 12 is in the stretched position relative to the lower push rod 11 (i.e., a position that may be operated), the operating handle 14 may be rotated and fixed in the first position. At this time, the stopping member 19 presses against the limiting plate 17, while the second cam 82 presses against the flexible member 83, strictly limiting the telescopic movement of the upper push rod 12 relative to the lower push rod 11. At this time, the cam does not trigger the safety switch 5, and the lawnmower 100 may be started normally. When the user needs to store the push rod mechanism 1, the operating handle 14 is switched to the second position, the stopping member 19 gives way to the limiting plate 17, and the second cam 82 no longer presses against the flexible member 83, thereby allowing the limiting ball 18 and the flexible member 83 to exit the position-position-limiting state. In this case, the user only needs to apply a slight force to retract the upper push rod 12 into the lower push rod 11. It should be noted that when the operating handle 14 is turned to the second position, the cam 16 triggers the safety switch 5, and the lawnmower 100 in this state is not able to start the mowing operation.

In summary, the lawnmower 100 and its push rod mechanism 1 provided by the present disclosure, due to the mutual restriction of the operating member and the limiting member, the lawnmower 100 may only be triggered to start when the upper push rod 12 and the lower push rod 11 are stretched and retracted in place. During the operation of the lawnmower 100, the telescopic operation between the upper push rod 12 and the lower push rod 11 is prohibited. As two sets of telescopic control assemblies movable synchronously are provided, the stability of the push rod mechanism 1 is better, and the operation safety of the lawnmower 100 is better.

The present disclosure is not limited to the specific embodiments described above. Those skilled in the art may easily understand that there are many alternatives for the lawnmower and the push rod mechanism of the present disclosure without departing from the principle and scope of the present disclosure. The protection scope of the present disclosure shall be determined by the contents of the claims.

What is claimed is:

1. A push rod mechanism, comprising:
a lower push rod and an upper push rod relatively telescopic to each other; and
a telescopic control assembly sleeved at a joint position between the lower push rod and the upper push rod;
wherein the lower push rod defines a through hole passing through a side wall of the lower push rod; the telescopic control assembly comprises a limiting member at least partially accommodated in the through hole, the limiting member abuts against a side wall of the upper push rod and has a position-limiting state that restricts stretch and retraction of the upper push rod relative to the lower push rod; and
wherein the telescopic control assembly further comprises an operating member capable of pressing against the limiting member, and an operating handle configured to control movement of the operating member; the operating handle defines a first position and a second position and is able to move between the first position and the second position; in response to the operating handle being in the first position, the operating member presses against the limiting member to keep the limiting member in the position-limiting state; and in response to the operating handle being in the second position, the operating member gives way to the limiting member to allow the limiting member to exit the position-limiting state.

2. The push rod mechanism according to claim 1, wherein the operating handle rotates between the first position and the second position around a pivot shaft, the operating handle is connected to the pivot shaft, and the operating member is connected to the pivot shaft.

3. The push rod mechanism according to claim 2, wherein both the upper push rod and the lower push rod are hollow tubular members; the through hole comprises a positioning hole passing through a tube wall of the lower push rod, the upper push rod is provided with a limiting hole passing through a tube wall of the upper push rod and coincident with the positioning hole; the limiting member comprises a first limiting member, and the first limiting member has a tendency to enter the limiting hole to limit stretch and retraction of the upper pushing rod relative to the lower pushing rod.

4. The push rod mechanism according to claim 3, wherein the telescopic control assembly comprises a shell accommodating the first limiting member and the operating member; the first limiting member comprises a limiting plate pivotally connected to the shell and a limiting ball connected to the limiting plate; the limiting ball is at least partially accommodated in the positioning hole, and a diameter of the limiting ball is equivalent to a size of the positioning hole.

5. The push rod mechanism according to claim 4, wherein the telescopic control assembly further comprises an elastic member disposed between the limiting plate and the shell, and the limiting plate has a tendency to push the limiting ball into the limiting hole under elastic force of the elastic member.

6. The push rod mechanism according to claim 5, wherein the operating member comprises a first operating member, the first operating member is a stopping member arranged at the pivot shaft, the stopping member is arranged adjacent to the limiting plate in an axial direction of the pivot shaft; in response to the operating handle being in the first position, the stopping member at least partially overlaps with the limiting plate along a circumferential direction of the pivot shaft; and in response to the operating handle being in the second position, the stopping member is staggered with the limiting plate along the circumferential direction of the pivot shaft.

7. The push rod mechanism according to claim 3, wherein the through hole of the lower push rod further comprises a strip hole defined on one side of the lower push rod facing the pivot shaft, the limiting member further comprises a second limiting member, the second limiting member is a flexible member accommodated in the strip hole, and the flexible member passes through the strip hole and abuts against a side wall of the upper push rod.

8. The push rod mechanism according to claim 7, wherein the operating member further comprises a second operating member synchronously rotating with the first operating member, the second operating member is a second cam arranged around the pivot shaft; the second cam is aligned with the flexible member along an axial direction of the pivot shaft, the second cam has a part with a short diameter and a part with a long diameter around an outer circumference of the pivot shaft; in response to the operating handle being in the first position, the part with the long diameter presses against the flexible member; in response to the operating handle being in the second position, the part with the short diameter faces the flexible member.

9. The push rod mechanism according to claim 8, wherein the telescopic control assembly further comprises a receiving part located between the flexible member and the second cam, and the receiving part is configured to receive and support the flexible member.

10. The push rod mechanism according to claim 1, comprising:
a start switch and a safety switch connected to the start switch, wherein the safety switch is arranged in the telescopic control assembly; in response to the operating handle being in the second position, the safety switch is triggered and the start switch is restricted to start; in response to the operating handle being in the first position, the safety switch is not triggered and the start switch is allowed to start.

11. A lawnmower, comprising:
a housing, a grass collection bag located behind the housing, and a push rod mechanism located on two sides of the housing;
wherein the push rod mechanism is located above the grass collection bag;
wherein the push rod mechanism comprises a lower push rod and an upper push rod relatively telescopic to each other; and a telescopic control assembly sleeved at a joint position between the lower push rod and the upper push rod;
the lower push rod defines a through hole passing through a side wall of the lower push rod;
the telescopic control assembly comprises a limiting member at least partially accommodated in the through hole, the limiting member abuts against a side wall of the upper push rod and has a position-limiting state that restricts stretch and retraction of the upper push rod relative to the lower push rod; and
the telescopic control assembly further comprises an operating member capable of pressing against the limiting member, and an operating handle configured to control movement of the operating member; the operating handle defines a first position and a second position and is able to move between the first position and the second position; in response to the operating handle being in the first position, the operating member presses against the limiting member to keep the limiting member in the position-limiting state; and in response to the operating handle being in the second position, the operating member gives way to the limiting member to allow the limiting member to exit the position-limiting state.

12. The lawnmower according to claim 11, wherein the operating handle rotates between the first position and the second position around a pivot shaft, the operating handle is connected to the pivot shaft, and the operating member is connected to the pivot shaft.

13. The lawnmower according to claim 12, wherein both the upper push rod and the lower push rod are hollow tubular members; the through hole comprises a positioning hole passing through a tube wall of the lower push rod, the upper push rod is provided with a limiting hole passing through a tube wall of the upper push rod and coincident with the positioning hole; the limiting member comprises a first limiting member, and the first limiting member has a tendency to enter the limiting hole to limit stretch and retraction of the upper pushing rod relative to the lower pushing rod.

14. The lawnmower according to claim 13, wherein the telescopic control assembly comprises a shell accommodating the first limiting member and the operating member; the first limiting member comprises a limiting plate pivotally connected to the shell and a limiting ball connected to the limiting plate; the limiting ball is at least partially accommodated in the positioning hole, and a diameter of the limiting ball is equivalent to a size of the positioning hole.

15. The lawnmower according to claim 14, wherein the telescopic control assembly further comprises an elastic member disposed between the limiting plate and the shell, and the limiting plate has a tendency to push the limiting ball into the limiting hole under elastic force of the elastic member.

16. The lawnmower according to claim 15, wherein the operating member comprises a first operating member, the first operating member is a stopping member arranged at the pivot shaft, the stopping member is arranged adjacent to the limiting plate in an axial direction of the pivot shaft; in response to the operating handle being in the first position, the stopping member at least partially overlaps with the limiting plate along a circumferential direction of the pivot shaft; and in response to the operating handle being in the second position, the stopping member is staggered with the limiting plate along the circumferential direction of the pivot shaft.

17. The lawnmower according to claim 13, wherein the through hole of the lower push rod further comprises a strip hole defined on one side of the lower push rod facing the pivot shaft, the limiting member further comprises a second limiting member, the second limiting member is a flexible member accommodated in the strip hole, and the flexible member passes through the strip hole and abuts against a side wall of the upper push rod.

18. The lawnmower according to claim 17, wherein the operating member further comprises a second operating member synchronously rotating with the first operating member, the second operating member is a second cam arranged around the pivot shaft; the second cam is aligned with the flexible member along an axial direction of the pivot shaft, the second cam has a part with a short diameter and a part with a long diameter around an outer circumference of the pivot shaft; in response to the operating handle being in the first position, the part with the long diameter presses against the flexible member; in response to the operating handle being in the second position, the part with the short diameter faces the flexible member.

19. The lawnmower according to claim 18, wherein the telescopic control assembly further comprises a receiving part located between the flexible member and the second cam, and the receiving part is configured to receive and support the flexible member.

20. The lawnmower according to claim 11, comprising:
a start switch and a safety switch connected to the start switch, wherein the safety switch is arranged in the telescopic control assembly; in response to the operating handle being in the second position, the safety switch is triggered and the start switch is restricted to start; in response to the operating handle being in the first position, the safety switch is not triggered and the start switch is allowed to start.
